(19) United States
(12) Patent Application Publication
(10) Pub. No.: US 2018/0104907 A1
(43) Pub. Date: Apr. 19, 2018

(54) MACHINE FOR WELDING SADDLE CONNECTORS BY POLYWELDING IN PIPE LAYING

(71) Applicant: RITMO S.P.A., Teolo ( Padova) (IT)

(72) Inventor: RENZO BORTOLI, Montegrotto Terme ( Padova) (IT)

(21) Appl. No.: 15/718,606

(22) Filed: Sep. 28, 2017

(30) Foreign Application Priority Data
Oct. 18, 2016 (IT) 102016000104112
Oct. 18, 2016 (IT) UA2016A007410

(51) Int. Cl. B29C 65/00; B29C 65/02; B29C 65/74

(52) U.S. Cl. CPC B29C 66/53243; B29L 2023/22; B29C 65/7457; B29C 65/02

(57) ABSTRACT

A machine for welding saddle connectors by polywelding, during pipe laying, includes a base which extends in a first direction, a clamp which can move along the base in the first direction, a bracket mounting means for detachably coupling the machine to a pipe arranged transversely to the first direction, and a means for detachably coupling the base to the bracket mounting means.

### BACKGROUND OF THE INVENTION

The present invention relates to a machine for welding saddle connectors by polywelding in pipe laying.

It is known, in the field of apparatuses for the conveyance of fluids, such as water, gas or the like, provided by means of pipes made of thermoplastic material, to use saddle connectors in order to make branches from a main line in a practical and reliable manner.

The installation of a saddle connector by polywelding requires first of all drilling with a hollow cutter of appropriate size the wall of the pipe on which the connector is to be fitted.

Then, by means of a polywelding device, the parts to be welded are heated and when they have reached the ideal temperature the saddle connector is welded to the pipe, by inserting the connector in the previously provided opening and by applying adequate pressure between the parts.

Although the installation of those saddle connectors may appear relatively simple, it is actually rather delicate, and requires particular skill on the part of the assigned operators who has to make the hole correctly and seek the correct relative position of the components to be welded.

It is in fact indispensable that the hole is centered with respect to the axis of the main line and also perpendicular to this axis.

Also, one must also take care that during polywelding the parts to be welded are kept perfectly axially mutually aligned for a time that is sufficient to produce their final coupling.

This already difficult situation, becomes even more complex if the above saddle connectors must be installed during the pipe laying operation, possibly working in confined spaces.

It should be considered in this regard that in the building yard sector all the operations required for the installation of saddle connectors by polywelding are currently performed manually by operators, entrusting the quality of the final result exclusively to their skill.

### OBJECTS OF THE INVENTION

The aim of the invention is therefore to provide a machine, for welding saddle connectors by polywelding during pipe laying, which can at least partially free the operators from the burden of the tasks described above.

Within the scope of this aim, a particular object of the invention is to provide a machine that allows to obtain perfect alignment and perfect perpendicularity both during the drilling of the main line and during the insertion and welding of the saddle connector.

Another object of the invention is to provide a machine that allows to work on a main line without ever changing or modifying the axis on which one is working.

Another object of the invention is to provide a machine that is lightweight, comfortable and easy to handle, so much that it can be used even by a single operator.

Another object of the invention is to provide a machine that is tough, compact and safe for the operator.

### SUMMARY OF THE INVENTION

This aim, these objects and others which will become better apparent hereinafter are achieved by a machine for welding saddle connectors by polywelding in pipe laying, comprising a base extending in a first direction, at least one clamp which can move along said base in said first direction, a bracket mounting means in order to detachably couple said machine to a pipe arranged transversely to said first direction, and a means for detachably coupling said base to said bracket mounting means.

### BRIEF DESCRIPTION OF THE DRAWINGS

Further characteristics and advantages will become better apparent from the description of a preferred but not exclusive embodiment of a machine for welding saddle connectors by polywelding, according to the invention, illustrated by way of nonlimiting example in the accompanying drawings, wherein:

FIG. 1 is a perspective view of the machine according to the invention;

FIG. 2 is another perspective view of the machine according to the invention;

FIG. 3 is another perspective view of the machine according to the invention;

FIG. 4 is a perspective view of the machine according to the invention during a step of use;

FIG. 5 is a perspective view of the machine according to the invention during another step of use;

FIG. 6 is a perspective view of the machine according to the invention during another step of use;

FIG. 7 is a perspective view of the machine according to the invention after the installation of a saddle connector on a pipe.

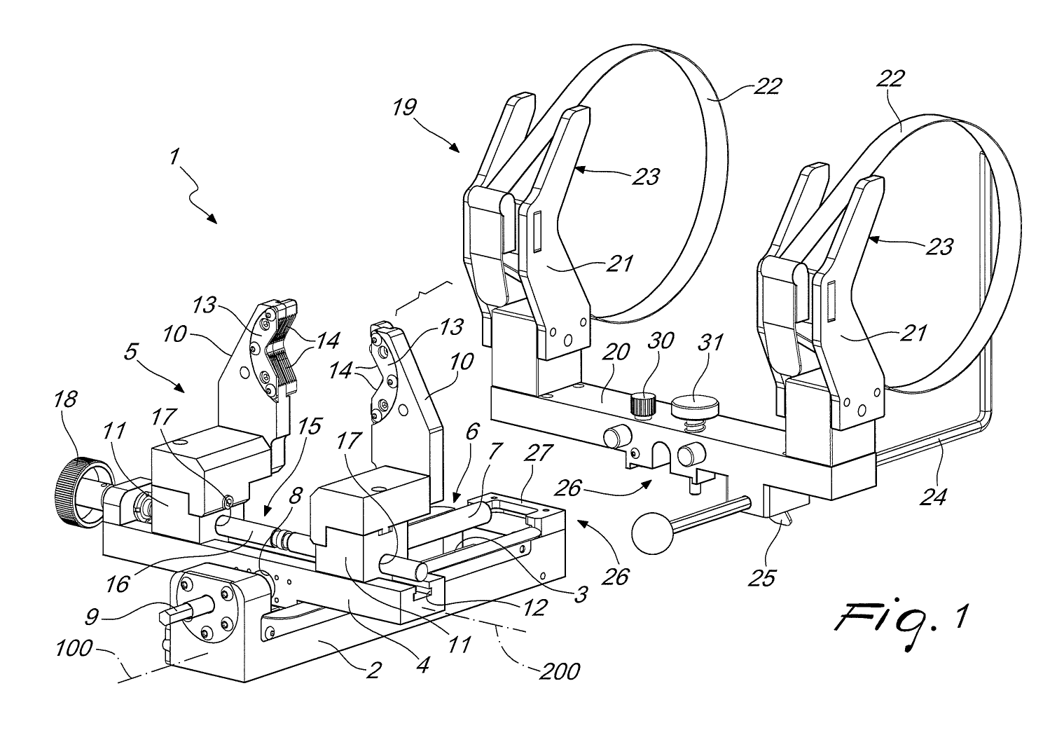

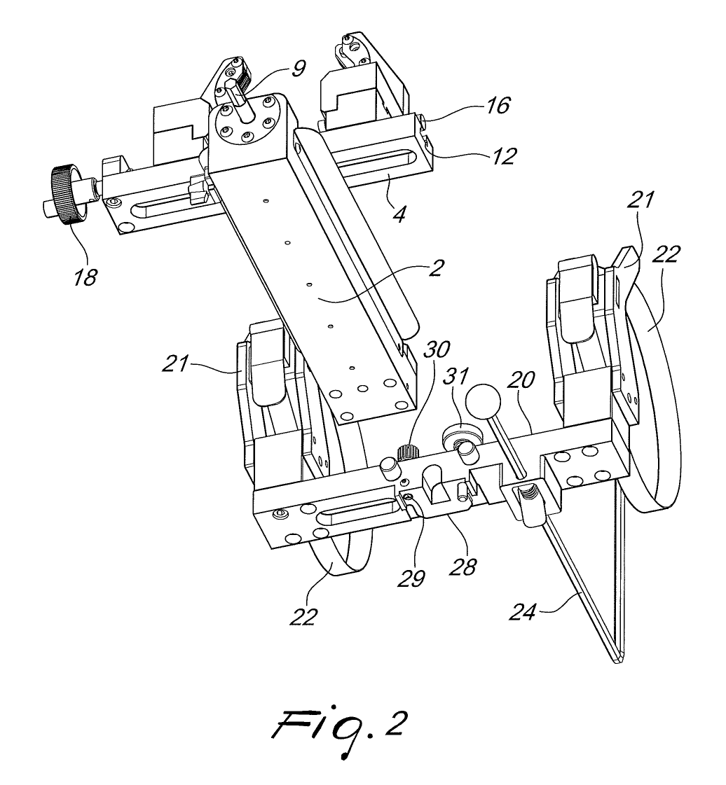

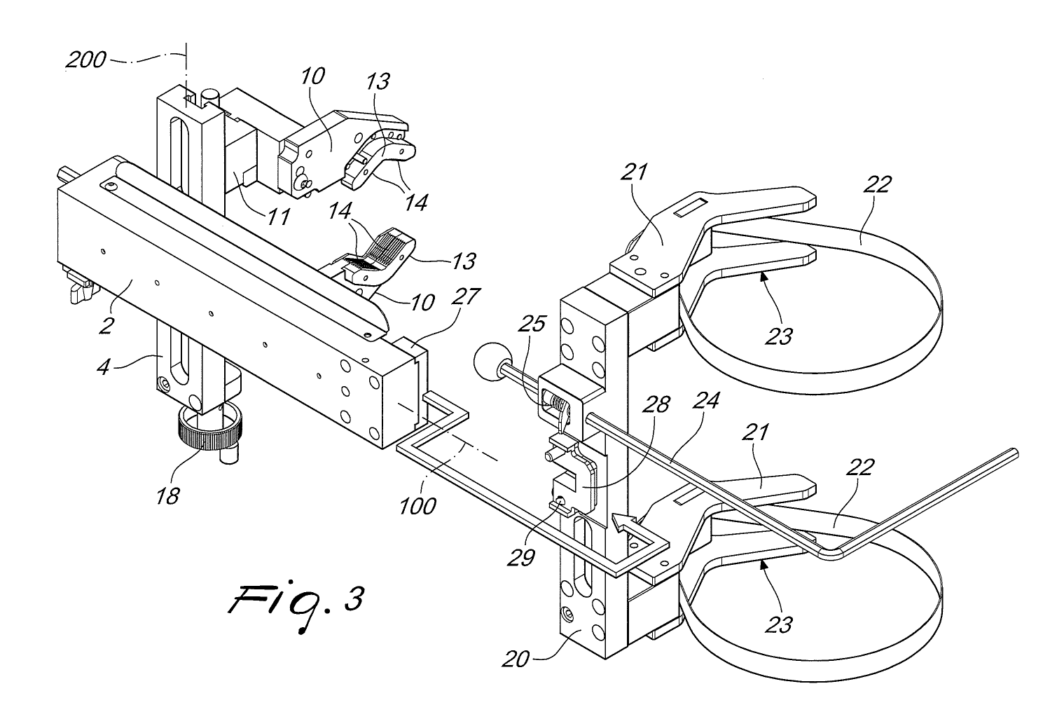

### DETAILED DESCRIPTION

With reference to the cited figures, a machine for welding saddle connectors by polywelding, according to the invention, is designated generally by the reference numeral 1.

The machine 1 includes an elongated base 2, which predominantly extends in a first direction 100.

A first sliding guide 3 is arranged on the base 2 and also extends in the first direction 100.

A carriage 4 is slidingly associated with the first sliding guide 3 and supports a clamp 5, which is movable along the base 2 in the first direction 100.

Advantageously, a first means 6 for the movement of the carriage 4 is mounted on the base 2 and allows to move the carriage along the first sliding guide 3 under the control of an operator who operates the machine 1.

In greater detail, this first movement means 6 essentially consists of a first worm screw 7, which is coupled to a corresponding first female thread 8 provided on the carriage 4.

The first worm screw 7 is arranged so that its rotation axis is substantially parallel to the first direction 100 and has an end portion 9 which allows the operator to turn it by means of an electric tool (drill, screwdriver, etc.), or by means of a manual crank suitable for the purpose.

The clamp 5 includes a pair of mutually opposite jaws 10, which can move with respect to each other by moving along a second direction 200 which is substantially perpendicular to the first direction 100.

Each jaw 10 has, for this purpose, a base portion 11 which is slidingly associated with a second sliding guide 12 which is arranged on the carriage 4 and is extended in the second direction 200.

The jaws 10 are also provided with respective locking portions 13 that define substantially V-shaped abutment profiles 14.

Advantageously, a second movement means 15 is mounted on the carriage 4 and allows to move the jaws 10 along the second sliding guide 12 under the control of the operator.

This second movement means 15 essentially consists of a second worm screw 16, with a right-handed end and another left-handed end, which is coupled to corresponding second female threads 17 provided on the base portions 11 of the jaws 10.

The second worm screw 16 is arranged so that its rotation axis is substantially parallel to the second direction 200 and can be rotated by the operator by means of a handwheel 18.

Advantageously, the handwheel 18 can be connected equally to either end of the second worm screw 16, choosing the side of the base 2 that is most convenient in terms of maneuvering space.

The machine 1 also includes a bracket mounting means 19, which keeps it firmly but detachably coupled to a pipe 50 which is arranged transversely to the first direction 100.

This bracket mounting means 19 is constituted essentially by a support 20, to which two brackets 21 are coupled which are provided with a means 22 for retention of the pipe 50.

Conveniently, each bracket 21 forms an abutment profile 23 that is substantially V-shaped.

In the specific case, the retention means 22 can be constituted by belts of the ratchet type, such as the ones shown in the figures, or by other systems capable of closing by adjustable progressive tightening the bend that wraps around the pipe 50.

Advantageously, the bracket mounting means 19 also includes a grip member 24 that is formed by two mutually perpendicular arms which give it a substantially L-shaped configuration.

The grip member 24 is mounted so that it can move on the support 20 and is conceived so as to temporarily engage the bracket mounting means 19, and therefore the machine 1, with the pipe 50 until the retention means 22 is activated.

In particular, the longer arm of the grip member 24 is slidingly associated with the support 20 and its strokes can be blocked by means of an interference locking system 25, which is per se known.

According to a further advantageous aspect of the present invention, the bracket mounting means 19 is associated with the base 2 detachably.

The machine 1 in fact includes a detachable engagement means 26 which allows to separate the bracket mounting means 19 from the base 2 or to rigidly couple these two members, depending on the specific requirements.

In order to rigidly couple the bracket mounting means 19 to the base 2, the base 2 is provided at one of its ends with a hook-shaped portion 27 which can be engaged by interlocking, by means of a sliding motion along the first direction 100, with a corresponding edge 28 provided on the support 20.

Conveniently, the detachable engagement means 26 includes a snap engagement device which allows to automatically fasten the base 2 to the support 20, so as to ensure the safety of the operator, avoiding unwanted separations of these two members.

This snap engagement device can include, for example, a tooth 29 biased by a spring, not shown in the figures; the tooth 29 cooperates by snap action with a recess, also not shown in the figures, formed on the base 2.

The tooth 29 can move with respect to the support 20 and can slide axially along a direction that is transverse to the first direction 100.

Advantageously, the tooth 29 has, at one of its ends, a grip knob 30 which allows to release the snap engagement device.

The detachable engagement means 26 also includes a handwheel 31 that is adapted to firmly couple the base 2 to the support 20, eliminating any mechanical plays in the coupling between the two elements.

The use of this machine is described hereinafter.

To begin with, it is necessary to locate the point in the pipe 50 where one wishes to form the branch.

Once the precise point has been located, it is convenient to separate the base 2 from the support 20 and fasten only the bracket mounting means 19 to the pipe 50.

Because the machine 1 is divided into two parts, the operator can in fact manage the weights involved more easily and with greater safety.

In order to fasten the bracket mounting means 19 to the pipe 50, first of all the grip member 24 is used.

The shorter arm of the grip member 24 is made to pass behind the pipe 50 and then its longer arm is made to slide with respect to the support 20 until the pipe 50 rests on the abutment profile 23 of the brackets 21.

Conveniently, the interference locking system 25 automatically prevents the grip member 24 from sliding in the opposite direction.

In this manner, the bracket mounting means 19 hangs from the pipe 50, allowing the operator to render the retention means 22 operational in full safety.

From a practical standpoint, the activation of the retention means 22 consists in passing the belts around the pipe 50 so as to form bends that wrap around it, and in progressively tightening the bends by means of the ratchets.

Once the retention means 21 has been tightened, the bracket mounting means 19 can no longer rotate or slide along the pipe 50.

At this point the base 2 can be attached to the bracket mounting means 19 already previously fastened to the pipe 50.

By virtue of a sliding motion along the first direction 100, the hook-shaped portion 27 of the base 2 is interlocked with the edge 28 provided on the support 20.

When the base 2 and the support 20 are correctly positioned with respect to each other, the tooth 29, pushed by the spring, engages by snap action against the corresponding recess formed on the base 2.

The automatic engagement of the base 2 with the support 20 is thus achieved, and therefore they become monolithic.

This ensures, once again, that the operator is placed in a safe situation, since the base 2 and all the components of the machine 1 associated therewith can no longer disengage accidentally, sliding onto him.

Subsequently, in order to ensure the elimination of any mechanical plays between the base 2 and the support 20 it is sufficient to fix the handwheel 31 that is close to the grip knob 30.

Before or after this operation, a first electric tool 60, equipped with a hollow cutter 61, is clamped between the locking portions 13 of the jaws 10.

At this point it is possible to proceed with the drilling of the pipe 50, as shown in the accompanying FIG. 4.

For this purpose, the first electric tool 60 is started, preferably locking its switch in the on position, and, by means of a second electric tool 70 (drill, screwdriver, etc.) connected to the end portion 9 of the first worm screw 7, the first electric tool 60 is made to advance along the first direction 100 until the pipe 50 is perforated.

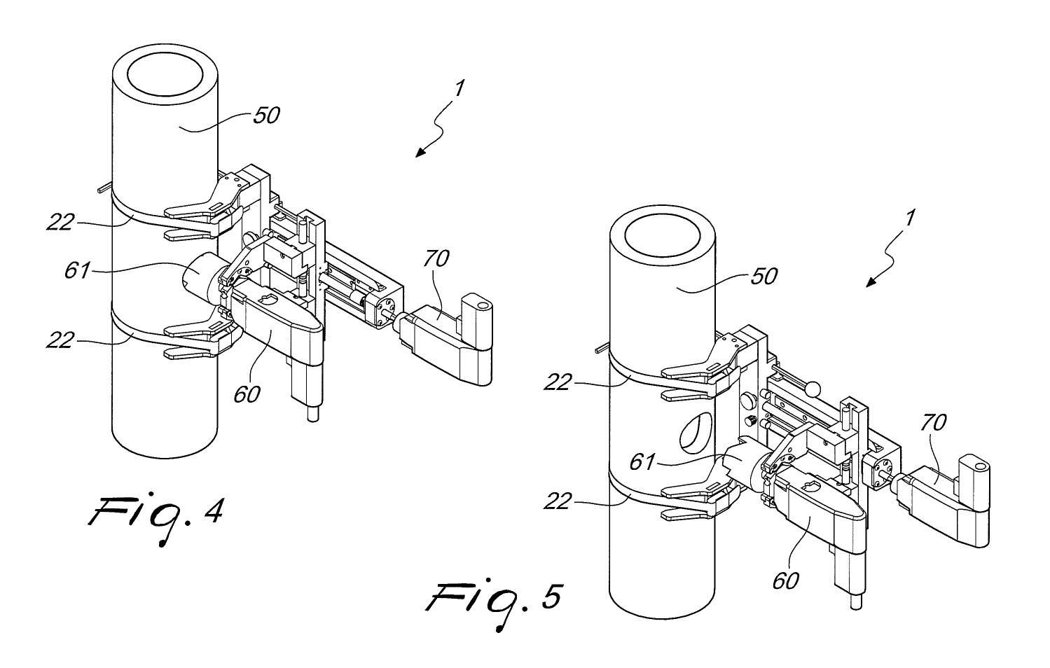

When the hollow cutter 61 has excavated the entire surface and has entered the pipe 50, as can be seen in FIG. 5, the direction of travel of the second electric tool 70 is reversed until it is possible to remove the first electric tool 60 from the clamp 5.

Once the first electric tool 60 has been turned off, the operator can pick it up, open the jaws 10 and remove it from the machine 1.

A connector 90 is then arranged between the locking portions 13 of the jaws 10 and is clamped between the abutment profiles 14, making sure that the concentricity between the pipe 50 and the connector 90 is as precise as possible.

At this point a polywelding device 18, turned on and heated to its operating temperature, is inserted as shown in FIG. 6 between the pipe 50 and the connector 90, and the carriage 4 is made to advance, by means of the second electric tool 70, until the radially shaped surfaces of the bushes 81 are in contact with the ones of the pipe 50 and of the connector 90.

When the surfaces in contact with the bushes 81 have reached the ideal temperature, the carriage 4 is made to retract, by means of the second electric tool 70, and the polywelding device 80 is removed.

Once the polywelding device 80 has been removed, it is necessary to proceed as quickly as possible to weld the connector 90 to the pipe 50; to do so, it is necessary to again reverse the direction of rotation of the second electric tool 70, making the carriage 4 advance up to the complete insertion of the connector 90 in the pipe 50.

Once it has been ascertained that the welding operation has been performed correctly, it is possible to proceed with the opening of the jaws 10.

In order to remove the machine 1 from the pipe 50, it is convenient first of all to detach the second electric tool 70 from the end portion 9 of the first worm screw 7.

Then, after loosening the handwheel 31 and lifting the grip knob 30 so as to disengage the tooth 29 from the recess formed on the base 2, it is possible to disengage the base 2 from the support 20.

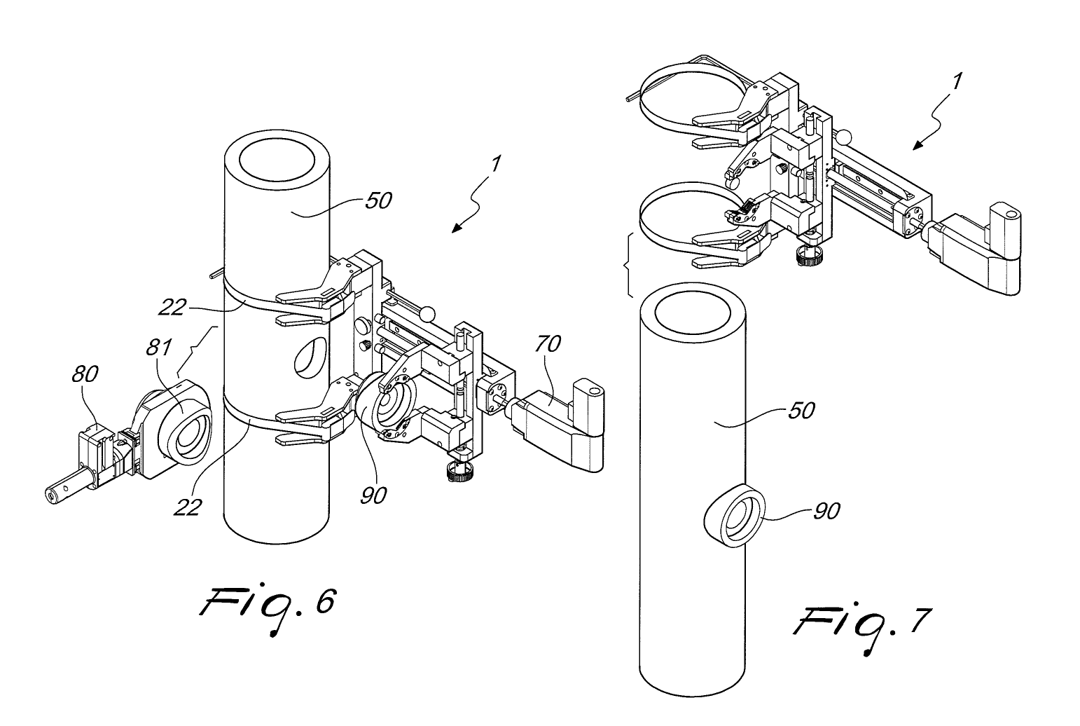

The removal of the machine 1 from the pipe 50 is completed by loosening the retention means 22 and deactivating the interference locking system 25, so as to make the grip member 24 slide enough to allow the disengagement of the bracket mounting means 19 from the pipe 50, as can be seen in FIG. 7.

In practice it has been found that the machine for welding saddle connectors by polywelding, during the pipe laying operation, according to the invention, fully achieves the intended aim, allowing to obtain perfect alignment and perfect perpendicular arrangement, first in the drilling of the pipe and then in the welding and insertion of the connector in the pipe, without ever changing or modifying the axis on which one is working.

This allows to provide precision drilling of superior quality, welds which are axially aligned with the center of the pipe, and insertions of the connector without flash or misalignments.

Moreover, by virtue of the motorized advancement first of the cutter and then of the connector, the effort and the possibilities of error on the part of the operator are minimized.

Another important feature of the machine according to the invention is that it is in practice divided into two parts, although these parts can be rendered monolithic.

This leads to a better and easier management of the weights and also allows a single operator to use the machine according to the invention in the installation of saddle connectors.

The machine for welding saddle connectors by polywelding in pipe laying thus conceived is susceptible of numerous modifications and variations, all of which are within the scope of the inventive concept; all the details may be replaced with other technically equivalent elements.

In practice, the materials used, so long as they are compatible with the specific use, as well as the contingent shapes and dimensions, may vary according to the requirements and to the state of the art.

1. A machine for welding saddle connectors by polywelding in pipe laying, comprising a base extending in a first direction, at least one clamp which can move along said base in said first direction, a bracket mounting means in order to detachably couple said machine to a pipe arranged transversely to said first direction, and a means for detachably coupling said base to said bracket mounting means.

2. The machine according to claim 1, wherein said base comprises a first sliding guide which extends in said first direction and a carriage which supports said clamp; said carriage being slidingly associated with said first sliding guide.

3. The machine according to claim 2, wherein said base comprises a first movement means adapted to move said carriage along said first sliding guide under the control of an operator who operates said machine.

4. The machine according to claim 3, wherein said first movement means comprises at least one first worm screw which is associated with said base and is arranged so that the rotation axis is substantially parallel to said first direction; said first worm screw being coupled to a corresponding first female thread provided on said carriage; said first worm screw being rotationally actuatable by said operator.

5. The machine according to claim 2, wherein said clamp comprises a pair of mutually opposite jaws; said jaws being movable with respect to each other along a second direction that is substantially perpendicular to said first direction.

6. The machine according to claim 5, wherein said carriage comprises a second sliding guide which extendes in said second direction; said jaws comprising respective base portions which are slidingly associated with said second sliding guide.

7. The machine according to claim 5, wherein said jaws comprise respective locking portions; each locking portion forming a substantially V-shaped abutment profile.

8. The machine according to claim 5, wherein said carriage comprises a second movement means adapted to move said jaws along said second sliding guide under the control of said operator.

9. The machine according to claim 8, wherein said second movement means comprises at least one second worm screw which is associated with said carriage and is arranged so that the rotation axis is substantially parallel to said second direction; said second worm screw being coupled to a pair of corresponding second female threads which are provided respectively on said base portions of said jaws; said second worm screw being rotated by said operator.

10. The machine according to claim 9, wherein said movement means of said jaws comprise a handwheel which can be connected to the ends of said second worm screw selectively on the side of one of the two sides of said base.

11. The machine according to claim 1, wherein said bracket mounting means comprises a support which is detachably coupled to said base; said support supporting at least one pair of brackets provided with a retention means for retention of said pipe; each bracket forming a substantially V-shaped abutment profile.

12. The machine according to claim 11, wherein said retention means is constituted essentially by belts of the ratchet type which are adapted to close by adjustable progressive clamping the bend that wraps around said pipe.

13. The machine according to claim 11, wherein said bracket mounting means comprises at least one substantially L-shaped grip member; said grip member being mounted so that it can move on said support in order to temporarily engage said bracket mounting means to said pipe; said grip member being lockable by means of an interference locking system.

14. The machine according to claim 11, comprising means for the detachable engagement of said base with said bracket mounting means comprising a snap engagement device in order to automatically fasten said base to said support; said base being provided, at one of its ends, with a hook-shaped portion which can engage by interlocking a corresponding edge provided on said support.

15. The machine according to claim 14, wherein said snap engagement device comprises a recess which cooperates by snap action with a tooth pushed by a spring; said recess being formed on said base; said tooth being movable with respect to said support along a direction that is transverse to said first direction.

16. The machine according claim 11, comprising means for the detachable engagement of said base with said bracket mounting means comprising a locking handwheel for firmly coupling said base to said support; said handwheel being associated with said support.
